(19) United States
(12) Patent Application Publication
(10) Pub. No.: US 2013/0158977 A1
(43) Pub. Date: Jun. 20, 2013

(54) System and Method for Evaluating Speech Exposure

(71) Applicant: Andrew Senior, New York, NY (US)

(72) Inventor: Andrew Senior, New York, NY (US)

(21) Appl. No.: 13/159,789

(22) Filed: Jun. 14, 2011

(51) Int. Cl. G06F 17/27; G10L 15/00

(52) U.S. Cl. 704/9; 704/251; 704/E15.001; 704/E11.001

(57) ABSTRACT

Systems and methods are provided for detecting and analyzing speech spoken in the vicinity of a user. The detected speech may be analyzed to determine the quality, volume, complexity, language, and other attributes. A value metric may be calculated for the received speech, such as to inform parents of a child's progress related to learning to speak, or to provide feedback to a foreign language learner. A corresponding device may display the number of words, the value metric, or other information about speech received by the device.

### BACKGROUND

Recent research indicates that speech exposure during infancy may have a measurable impact on a person's vocabulary and cognitive development later in life. For example, it has been found that children as young as four years old that have been exposed to less speech or less varied speech may have more difficulty in developing extensive vocabularies than children that have been exposed to more or more varied speech.

Techniques to measure and analyze a child's speech exposure typically are very labor intensive, requiring hundreds of man-hours or more to record, identify, and transcribe the speech spoken to an infant. Such techniques are more suited to academic studies than practical use due to the data collection and processing times required.

### BRIEF SUMMARY

According to an embodiment of the disclosed subject matter, a method of analyzing speech exposure may include receiving audible speech spoken near a user and determining the language, source, quality, and/or complexity of the received speech. A value metric of the received speech may be determined based upon the determined language, source, quality, and/or complexity. The value metric may be provided to the user or to other computing systems and/or users.

A device according to an embodiment of the disclosed subject matter may include a microphone or other detector configured to receive audible speech spoken near a user. A processor in communication with the microphone and/or the device may detect a number of words in the audible speech. The device may include a display or other interface to provide the number of words detected in the speech.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process for receiving and analyzing speech according to an embodiment of the disclosed subject matter.

FIG. 2 shows an example special-purpose device and system according to an embodiment of the disclosed subject matter.

FIG. 3 shows an example device suitable for use with embodiments of the disclosed subject matter.

### DETAILED DESCRIPTION

It has been determined that the quantity and quality of speech heard by a listener in various contexts can have a large impact on the listener's success in various contexts, such as learning to speak or learning to speak a new language. Embodiments of the disclosed subject matter provide techniques and devices for monitoring, tracking, and evaluating the quantity and quality of speech heard by a listener.

For example, some embodiments may provide feedback for parents or other caregivers regarding the quantity and quality of speech heard by an infant. This can serve as a reminder parents to speak more, verify that a caregiver is speaking to the child, and verify the language of that speech. More generally, embodiments of the disclosed subject matter may provide information on speech heard by a user that indicates the likely or expected value of that speech in assisting the user to learn to speak.

As another example, embodiments may monitor a user's speech and provide information regarding the user's speech in a particular language, such as to notify a foreign-language learner that the user is not meeting a target of a particular number of words spoken in the language per day, or that the user has not used a particular construction, the practice of which is a goal for a particular day or other time period. More generally, embodiments of the disclosed subject matter may provide information to a user regarding speech spoken by the user.

A device according to an embodiment of the disclosed subject matter may include a small wearable tag or other device containing one or more microphones or equivalent audio detectors. The device may be configured to encode and/or analyze an acoustic signal received from the microphone. Alternatively or in addition, such a device may be configured to relay the acoustic signal or features derived from it to a local or remote processor for further processing. For example, the device may communicate with a local base-station attached to the owner's computer, a cloud-based or other network or remote system, or other processing system configured to analyze or log the acoustic signal or information derived from the signal. The acoustic signal may include speech spoken near or by a wearer or user of the device.

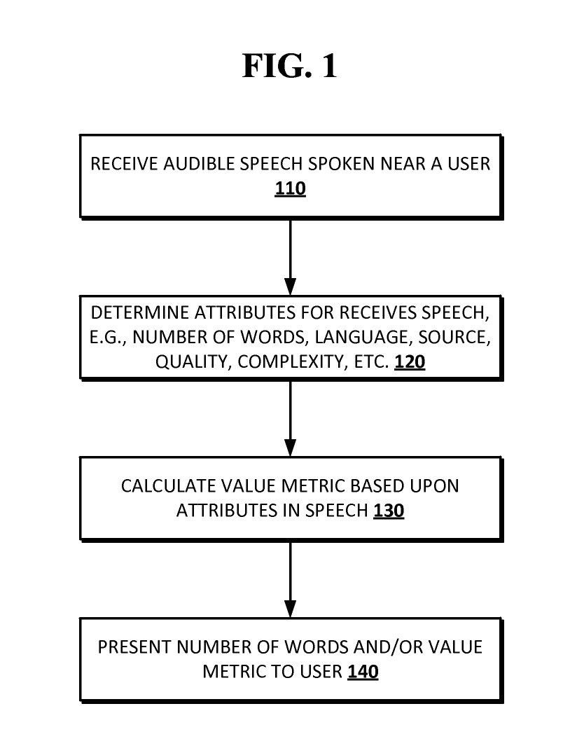

FIG. 1 shows an example process according to an embodiment of the disclosed subject matter. At 110, audible speech spoken near a user may be received. The speech may be spoken by one or more speakers, and may be directed toward the user or merely spoken in the physical vicinity of the user. Generally, any audible speech detectable by a microphone or other listening device configured to operate with an embodiment of the disclosed subject matter may be considered as being spoken near a user. In an embodiment, speech spoken “near” a user may be considered to include any speech having the minimum volume, power, pitch, and/or clarity necessary to be detectable or otherwise corresponding approximately to a level necessary to be detected by a human being, or by a human being of a particular age or age range.

The audible speech may be converted into various digital representations or other formats for efficient processing by one or more computer processors. At 120, various attributes may be determined for the received speech, such as the number of words, language, source, quality, complexity, or any combination thereof.

The number of words in the speech may be a count of any sound recognized by a processor as being an uttered word. Alternatively, the number of words in the speech may refer to the number of words in the audible speech that meet a predefined criteria, such as being of a particular language, source, quality, complexity, or any other criteria. The number of words also may be restricted to those determined to have been spoken to a user, as opposed to merely in the vicinity of the user. Thus, for example, an embodiment of the disclosed subject matter may determine the number of words heard by a user that are in a desired language, directed to the user, and of a desired complexity. Any other criteria or combination of criteria may be selected and applied to obtain a number of words in the received speech.

At 130, one or more processors may calculate a value metric of the received speech. The value metric may be based upon the attributes determined for the received speech, such as the determined language, source, quality, complexity, number of words, or any combination thereof of the received speech. The processor may be located locally, such as within a device worn or carried by the user, or it may be located remotely, such as within the user's computer, or at a remote or cloud-based service. In general, unless indicated otherwise herein, any processor used to implement embodiments of the disclosed subject matter may be located locally or remotely relative to the user or to a device that implements embodiments of the disclosed subject matter.

After the value metric is determined, it may be presented to a user at 140. For example, in an embodiment of the disclosed subject matter that incorporates a wearable or portable device, the device may include a display that shows the value metric. The display may be updated at any appropriate interval, such as whenever a particular threshold is reached, periodically, responsive to a user request, or continuously. The number of words detected in the speech, and/or the number of words in the detected speech that meet a predefined criteria, also may be presented. The value metric and/or the number of words may be provided on a local device, or may be provided to a remote system that performs additional processing and/or generates displays of the value metric, number of words, or other derived data.

The value metric may be based upon one or more attributes or a combination of various attributes. In an embodiment, the value metric may be based upon the number of words identified in the speech, or the number of words heard in the speech that are identified as meeting one or more other criteria. For example, the number of words heard during a set time period may be identified, such as the number of words heard each day. The number of words heard per unit time may be calculated and presented, such as the number of words per day, per hour, and so on. The number of words received may be determined based upon conventional speech detection and/or recognition algorithms. Depending upon the processing power available, words in the received speech may be determined directly at a local or remote processor. An approximation also may be made by detecting speech generally, and using the duration of detected speech as a proxy for the number of words that a hearer of the speech would be expected to hear.

In an embodiment, the value metric may be based upon the language of the received speech. For example, the language in which at least a portion of the received speech is spoken may be determined using conventional language detection algorithms. The amount of speech and/or number of words received in a particular language, or in each of a set of languages, may be logged. The number of words in a particular language may be determined and used to determine the value metric. For example, parents who want their child to hear a certain number of words each day in a given language may indicate which language should be tracked, and the number of words spoken in that language near the child may be determined. Similarly, a user learning a foreign language may set a goal of hearing a certain number of words in the language to be learned, and the value metric may indicate how close to the goal the user is during a particular time period. Generally, in an embodiment, the value metric may be based upon at least a determined language of the received speech, and may indicate the language in which at least a portion of the audible speech was spoken.

In an embodiment, the value metric may be based upon at least the source of the received speech and may indicate, for example, whether the received speech originates from a human speaker or an electronic source. For example, conventional algorithms may be used to determine whether received speech was spoken by a person present near the user, or from an electronic source such as a television, radio, computer, or the like. Examples of such algorithms include speaker identification, spectral analysis for known signal type fingerprints, content analysis, and the like. The value metric may consider speech spoken by a human to be preferred over electronic or other speech. For example, parents may prefer that their child be exposed to in-person speech as opposed to speech originating from television programs or other electronic sources.

In an embodiment, the value metric may be based upon at least the quality of the received speech, and may indicate the volume, speaker proximity, speaker accent, background noise level, background noise type, spectral type, or any combination of these or similar attributes. For example, the proximity of the speaker for a given portion of received speech may be determined using conventional speaker localization algorithms. In some cases multiple microphones or devices may be used to aid in such analysis. As another example, it may be determined whether the speech is colloquial or accented, such as where a user learning a foreign language prefers to be exposed to a particular accent, or where parents prefer that a child is exposed to a particular accent or subset of a particular language. The level and type of background noise may be determined, such as whether it includes music, traffic, other speech, and the like. Different types of background noise may be preferred, or it may be preferred to exclude certain types or levels of background noise. For example, a high level of traffic or other similar noise may be undesirable, whereas additional speech may be preferred. The value metric may be adjusted based upon preset or user-defined preferences for these attributes to reflect the desired quality of speech. Various techniques may be used to determine the quality of received speech. For example, the signal-to-noise ratio (S/N) of received speech within the entire audio received may be used to determine the quality, where a higher S/N indicates a higher quality of speech. As another example, a fundamental frequency analysis of the received audio may be used to determine the quality.

In an embodiment, the value metric may be based upon the complexity of the received speech and may indicate, for example, word frequency, sentence perplexity, sentence construction variation, grammatical correctness or incorrectness, or the like. For example, it may be preferred that the user is exposed to more complex sentences or vocabulary, or to a large vocabulary but relatively simple sentence structure. The complexity of speech may be determined based upon the number, length, and type of words detected in the speech, such as by comparison of the words to a dictionary or other source to determine the word length, complexity, part of speech, and the like. Similarly, word type or sentence construction may be determined by comparing identified words to a dictionary or other source to determine the type or part of speech for each word, then analyzing the variation in type by word or by known sentence structure combinations.

In an embodiment, the received speech may be spoken by the user. For example, a foreign language learner may wish to track the speech spoken by the learner, as opposed to speech spoken to or near the learner. Such a configuration may allow a user to determine if he is speaking in the foreign language a desired amount or frequency. More generally, in some configurations, embodiments of the disclosed subject matter may distinguish between speech that originates with the user, and speech that originates from a source other than the user. Techniques according to embodiments of the disclosed subject matter may therefore identify or distinguish speech spoken by the user and speech spoken by a speaker other than the user. Examples of techniques suitable for determining whether speech was spoken by the user or by another speaker may include speaker identification, spectral analysis for known signal type fingerprints, content analysis, and the like. For example, a device may be trained to recognize a specific voice as belonging to the user, based upon spectral analysis of training speech provided by the user prior to use among other speakers. The value metric may consider speech spoken by a human to be preferred over electronic or other speech. For example, parents may prefer that their child be exposed to in-person speech as opposed to speech originating from television programs or other electronic sources.

The value metric and other attributes or ratings as disclosed herein may be calculated with respect to speech spoken by the user, speech spoken by one or more other speakers, or any combination thereof. In some configurations, multiple value metrics may be calculated. For example, a parent may wish to determine the amount of speech spoken by a child user in a particular language and at a particular complexity, as well as the amount of speech spoken to the child in that language, such as by another caregiver.

The value metric may be a number, a description, or any other suitable indication of the valued attributes of received speech. For example, where a user has set various preferences as described above, the value metric may be an indication of “good” or “bad” conditions based on the relevant or selected factors. Similarly, it may be a score, such as between 1 and 10, 1 and 100, or the like, or a subjective score such as “acceptable,” “needs improvement,” or the like. The value metric also may provide one or more indications related to the attributes, such as to indicate that “higher quality speech needed,” “too much background noise,” “non-selected language,” or the like. The value metric may be provided on a device that receives the speech, such as a wearable or portable device, or it may be provided by a remote processing unit such as a computer or web page.

In an embodiment of the disclosed subject matter, received speech may be logged and stored to make it searchable and/or to analyze the speech, such as to determine the frequency or occurrence of a particular word, the first use of a particular word or a particular sound, or the like. The analysis may be performed locally or remotely from the device that receives the speech.

In an embodiment of the disclosed subject matter, feedback on pronunciation may be provided to assist in language learning. For example, the value metric may rate a user's pronunciation, or provide an indication of particular sounds or words that the user should focus on improving.

In an embodiment of the disclosed subject matter, a device may monitor the sound levels to which a person is exposed and provide an indication and/or logging of peak, current and net sound exposure. Such a configuration may be useful for preventing hearing loss, protecting workers, and the like.

Generally, any suitable device and configuration may be used to receive the speech and to analyze the received speech. For example, in an embodiment of the disclosed subject matter, the receiving and/or analysis device may be a cellphone that includes software and/or hardware to implement the techniques disclosed herein. The cellphone also may relay data to a remote processing unit, such as a remote server, a cloud-based service, or the like.

Embodiments of the disclosed subject matter may calculate and provide aggregate and/or instantaneous value metrics and other data. For example, a device may provide immediate feedback to indicate a mispronunciation, ungrammatical speech, or an unexpected language change such as using an English word in the middle of a French sentence, and the like. The device may provide the instantaneous value metric by lighting a light, providing a sound such as a spoken or displayed correction through a speaker or display, or other feedback. Embodiments of the disclosed subject matter also may provide techniques for providing immediate or aggregate audio feedback to a user, such as by playing back the speech that a device has detected.

Embodiments of the disclosed subject matter may include or make use of a variety of sensors in addition to or instead of those previously described, such as a camera, GPS receiver, accelerometer, thermometer, and the like. As a specific example, a camera for audio-visual speech recognition such as automated lip-reading. As another example, a GPS receiver may be used to link a user's location with speech spoken or heard, and the resulting value metric may indicate patterns in the user's speech with respect to location. Generally, any data collected by such sensors may be used to determine the value metric.

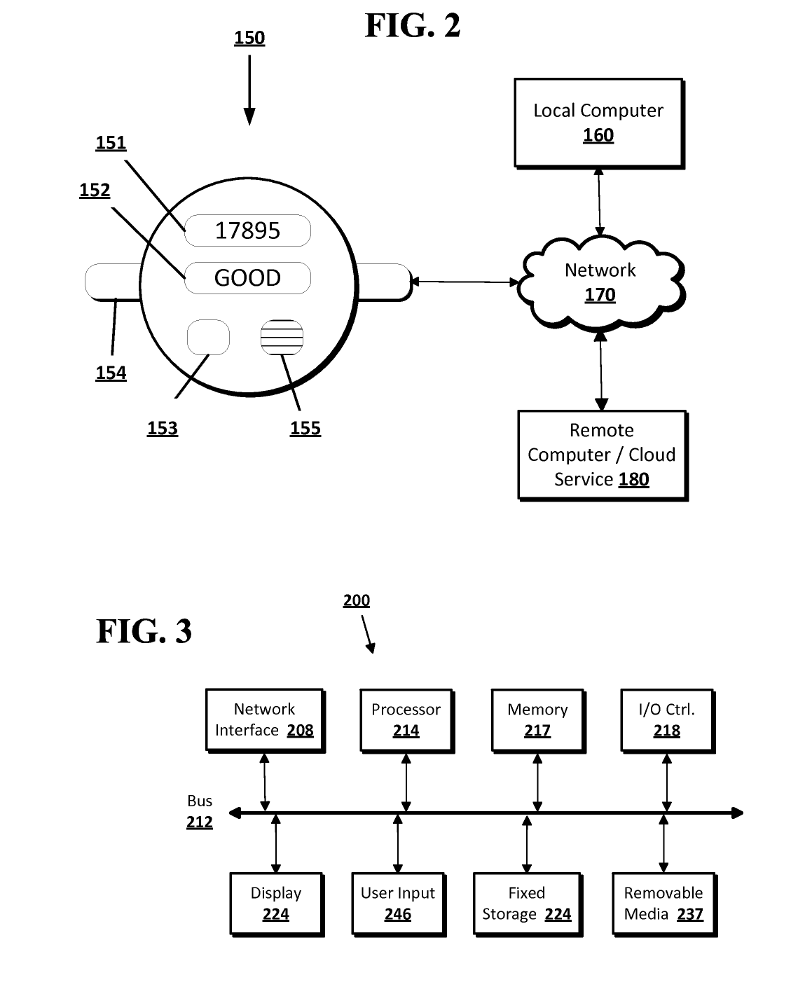

FIG. 2 shows an example device and system according to an embodiment of the disclosed subject matter. The device 150 may include a microphone 155 configured to receive audible speech spoken near a user. The microphone may be in communication with a processor configured to detect a number of words in the audible speech. The processor may be local or remote relative to the microphone. For example, the processor may be internal to the device 150, or may be in a local computer 160 and/or a remote computer or cloud-based service 180. The device 150 may communicate with any of the other components via a network 170, which may be any suitable network including wireless networks. It also may communicate with a local computer 160 via a direct connection such as a Universal Serial Bus (USB), IEEE 1394, or any other suitable connection.

The device may include one or more displays 151, 152 configured to display the number of words detected in the audible speech, a value metric, or other information about received speech as previously disclosed. The number of words may be words spoken near, to, or by the user as previously disclosed. The device may include one or more user interfaces, such as a button 153, to allow the user to interact with the device such as to reset a count 151, indicate that the device should start or stop, or cause the device to synchronize with another device such as a computer 160 or 180. Various components, such as the display(s) 151, 152, the microphone 155, and the like may be integrated within a single device, or one or more components may be separate physical devices connected via a communication link, which may be physical or wireless.

More generally, embodiments of the presently disclosed subject matter may be implemented in and used with a variety of device architectures. FIG. 3 is an example device 200 suitable for implementing embodiments of the presently disclosed subject matter. For example, the device 200 may implement the local computer 160, remote or cloud-based device 180, or the local device 150 as shown in FIG. 2 The computer system 200 includes a bus 212 which interconnects major subsystems of the computer system 210, such as a central processor 214, a system memory 217 (typically RAM, but which may also include ROM, flash RAM, or the like), an input/output controller 218, a user display 224, such as a display screen via a display adapter, a user input subsystem, which may include one or more controllers and associated user input devices such as a keyboard, mouse, and the like, fixed storage 224, such as a hard drive, flash storage, Fibre Channel network, SCSI device, and the like, and a removable media subsystem 237 operative to control and receive an optical disk, flash drive, and the like.

The bus 212 allows data communication between the central processor 214 and the system memory 217, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer system 200 are generally stored on and accessed via a computer readable medium, such as a hard disk drive (e.g., fixed storage 224), an optical drive, floppy disk, or other storage medium 237.

The fixed storage 224 may be integral with the computer system 200 or may be separate and accessed through other interface systems. The network interface 208 may provide a direct connection to a remote server via a telephone link, to the Internet via an internet service provider (ISP), or a direct connection to a remote server via a direct network link to the Internet via a POP (point of presence) or other technique. The network interface 208 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. The devices and subsystems can be interconnected in different ways from that shown. The operation of a computer system such the system 200 is readily known in the art and is not discussed in detail in this application. Code to implement the present disclosure can be stored in computer-readable storage media such as one or more of system memory 217, fixed storage 224, removable media 237, or on a remote storage location.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the method in accordance with embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the method in accordance with an embodiment of the disclosed subject matter.

The foregoing description and following appendices, for purpose of explanation, have been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. (canceled)

2. The method of claim 22, wherein the value metric is based upon at least the determined language of the received speech, and indicates the language in which at least a portion of the audible speech was spoken.

3. The method of claim 22, wherein the value metric is based upon at least the source of the received speech, and indicates whether the received speech originated from a human speaker or from an electronic source.

4. The method of claim 22, wherein the value metric is based upon at least the quality of the received speech, and indicates at least one of: volume, speaker proximity, speaker accent, level of background noise, type of background noise, or a combination thereof.

5. The method of claim 22, wherein the value metric is based upon at least the complexity of the received speech and indicates at least one of: word frequency, sentence perplexity, sentence construction variation, or a combination thereof.

6. (canceled)

7. The method of claim 21, further comprising discriminating speech spoken by the user from speech spoken by a speaker other than the user.

8. The method of claim 7, wherein the value metric of the received speech is determined for the speech spoken by the user.

9. The method of claim 7, wherein the value metric of the received speech is determined for the speech spoken by a speaker other than the user.

10. The method of claim 21, further comprising:
determining a number of words present in the received speech; and
presenting the number of words present in the received speech.

11. The method of claim 10, wherein the number of words present in the speech is a number of words in the received speech that meet a predefined criterion, the criterion based upon at least one selected from the group of: language, source, quality, or complexity of the received speech.

12. The method of claim 10, wherein the number of words present in the speech is a number of words in the received speech that are determined to have been directed at the user by the speaker.

13. The method of claim 22, wherein the value metric of the received speech is a number of words in the received speech that meets a requirement relating to the determined language, source, quality, complexity, or combination thereof of the received speech.

14.-20. (canceled)

21. A method comprising:
storing one or more attributes of speech, the one or more attributes relating to an analysis of speech;
receiving an update to the one or more attributes from a user to obtain user updated attributes, the user updated attributes reflecting at least one feature of speech desired by the user;
receiving audible speech spoken near the user;
calculating, by a processor, a value metric of the received speech based on the user updated attributes; and
providing an indication of the value metric of the received speech.

22. The method of claim 21, further comprising determining a language, source, quality, complexity, or a combination thereof of the received speech, wherein the at least one feature of speech desired by the user includes the language, source, quality, complexity, or combination thereof of the received speech.

23. The method of claim 21, further comprising:
obtaining a location of the user;
determining a pattern of the value metric with respect to the location of the user; and
providing an indication of pattern of the value metric of the received speech at the location.

24. The method of claim 21, further comprising:
determining a duration of the received speech; and
determining an approximate number of words in the received speech based on the duration; and
providing an indication of the approximate number of words in the received speech.

25. A method comprising:
obtaining a location of a user;
receiving audible speech spoken near the user at the location;
determining a language, source, quality, complexity, or a combination thereof of the received speech;
calculating, by a processor, a value metric of the received speech, the value metric based upon the determined language, source, quality, complexity, or combination thereof of the received speech;
determining a pattern of the value metric with respect to the location of the user; and
providing an indication of pattern of the value metric of the received speech at the location.

26. The method of claim 25, wherein the value metric is based upon at least the source of the received speech, and indicates whether the received speech originated from a human speaker or from an electronic source.

27. The method of claim 25, further comprising:
determining a duration of the received speech; and
determining an approximate number of words in the received speech based on the duration; and
providing an indication of the approximate number of words in the received speech.

28. A method comprising:
receiving audible speech spoken near a user;
determining a duration of the received speech;
determining an approximate number of words in the received speech based on the duration; and
providing an indication of the approximate number of words in the received speech.

29. The method of claim 28, further comprising discriminating speech directed at the user from other speech in the received speech, wherein determining the duration of the received speech comprises determining a specific duration of the speech directed at the user, and determining the approximate number of words in the received speech comprises determining an approximate number of words in the speech directed at the user based on the specific duration of the speech directed at the user.
